(19) United States
(12) Patent Application Publication
(10) Pub. No.: US 2005/0056740 A1
(43) Pub. Date: Mar. 17, 2005

(54) Rack for bicycle

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/919,562

(22) Filed: Aug. 16, 2004

(30) Foreign Application Priority Data
Aug. 29, 2003 (TW) 92124029

(51) Int. Cl. F16M 11/00; B60R 9/00; B60R 11/00

(52) U.S. Cl. 248/176.1

(57) ABSTRACT

A rack is disclosed for a bicycle. The rack includes a collapsible stand and a holder installed on the collapsible stand in order to hold the bicycle in position. The collapsible stand includes a post and at least three legs pivotally connected with the post. The holder includes a beam for supporting the down tube of the bicycle and a hook for hooking the handlebar of the bicycle.

### FIELD OF THE INVENTION

The present invention relates to a rack for a bicycle.

### BACKGROUND OF INVENTION

Referring to FIG. 14, a conventional rack has been devised for a bicycle. The rack includes a stand 50 and a holder 52. The holder 52 includes a seat 51 for supporting the bottom bracket of the bicycle, a hook 54 of hooking the down tube of the bicycle and a hook 53 for hooking the handlebar of the bicycle. This conventional rack is not collapsible and inevitably occupies a large space in use or not. It is inconvenient to store and carry this conventional rack.

The present invention is therefore intended to obviate or at least alleviate the problems encountered in prior art.

### SUMMARY OF THE INVENTION

According to the present invention, a rack is disclosed for a bicycle. The rack includes a collapsible stand and a holder installed on the collapsible stand in order to hold the bicycle in position.

The primary advantage of the rack according to the present invention is that it is collapsible in order to occupy a small space for storage.

Other objects, advantages and novel features of the present invention will become more apparent from the following detailed description referring to the attached drawings.

### BRIEF DESCRIPTION OF DRAWINGS

The present invention will be described via detailed illustration of the preferred embodiment referring to the drawings.

FIG. 1 is a perspective view of a rack for a bicycle according to the preferred embodiment of the present invention.

FIG. 2 is an exploded view of the rack shown in FIG. 1.

FIG. 3 is an enlarged partial view of the rack shown in FIG. 2.

FIG. 4 is a cross-sectional view of the rack shown in FIG. 1.

FIG. 5 is a cross-sectional view of the rack shown in FIG. 1.

FIG. 6 is a cross-sectional view of the rack shown in FIG. 1.

FIG. 7 is a side view of a bicycle held on the rack shown in FIG. 1.

FIG. 8 is a cross-sectional view of the rack shown in FIG. 1.

FIG. 9 is a side view of the bicycle held on the rack in a different position from that is shown in FIG. 7.

FIG. 10 is an enlarged partial view of the rack shown in FIG. 9.

FIG. 11 is a side view of the bicycle held on the rack in a different position from that is shown in FIG. 9.

FIG. 12 is a side view of the rack in a different position from that is shown in FIG. 1.

FIG. 13 is a perspective view of the rack in a different position from that is shown in FIG. 12.

FIG. 14 is a perspective view of a conventional rack for a bicycle.

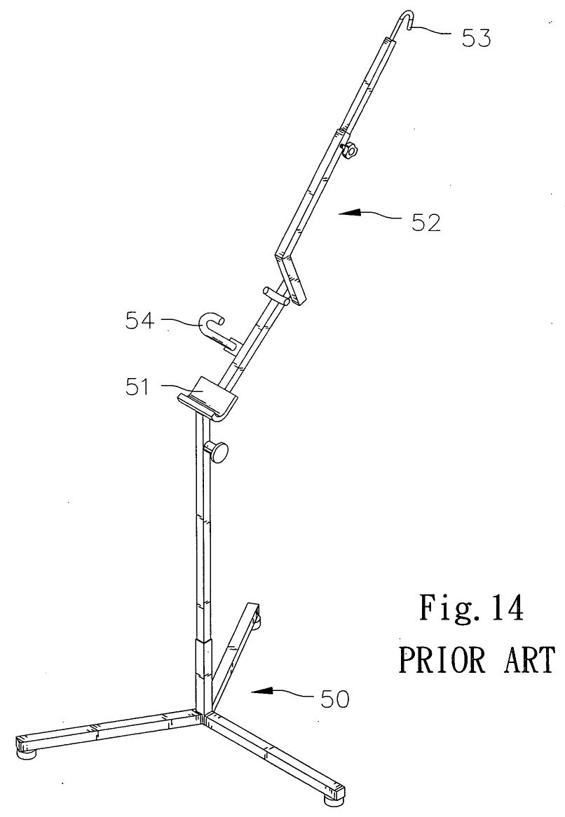

### DETAILED DESCRIPTION OF PREFERRED EMBODIMENT

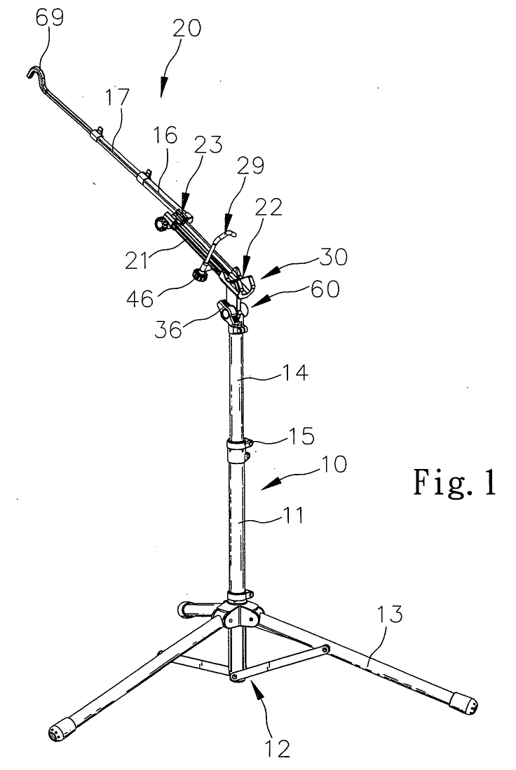

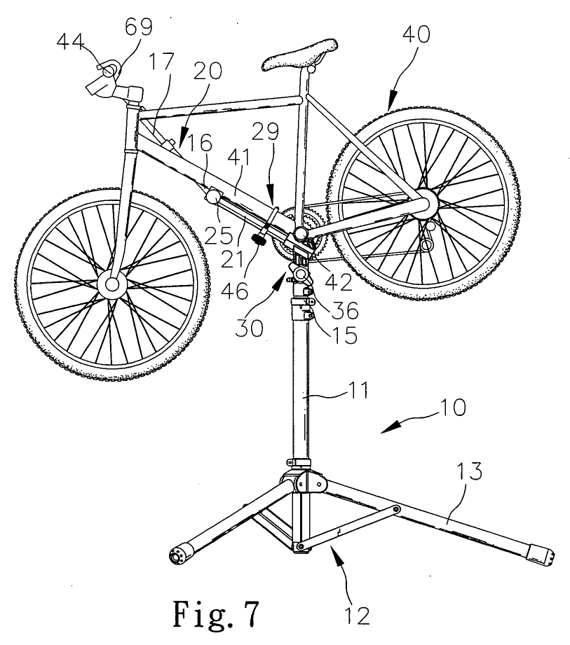

Referring to FIGS. 1 and 7, a rack according to the preferred embodiment of the present invention is provided for a bicycle 40. The rack includes a stand 10 installed on the ground or a floor, a holder 20 for holding a bicycle in position, a joint 30 for pivotally connecting the holder 20 with the stand 10 and a security device 60.

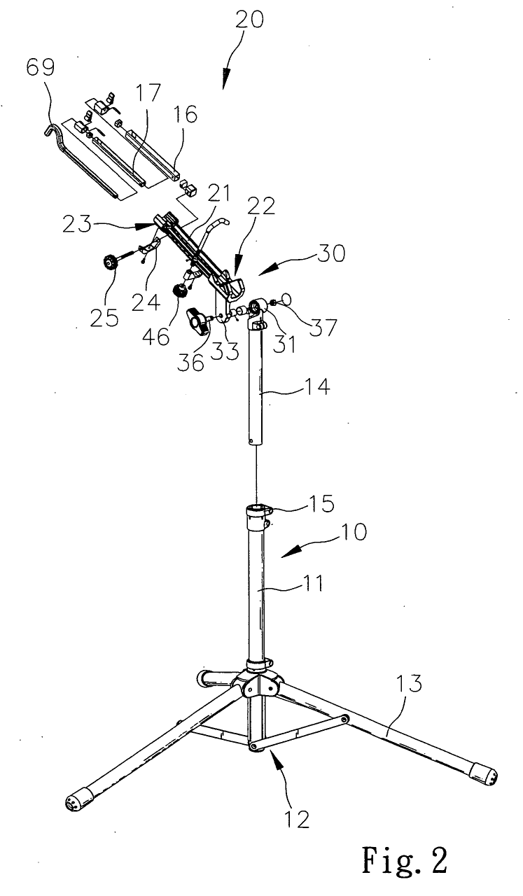

Referring to FIG. 2, the stand 10 includes three legs 13, a lower tube 11 supported by means of the legs 13, an upper tube 14 telescopically connected with the lower tube 11 and a quick release 15 for locking the upper tube 14 in a desired position on the lower tube 11.

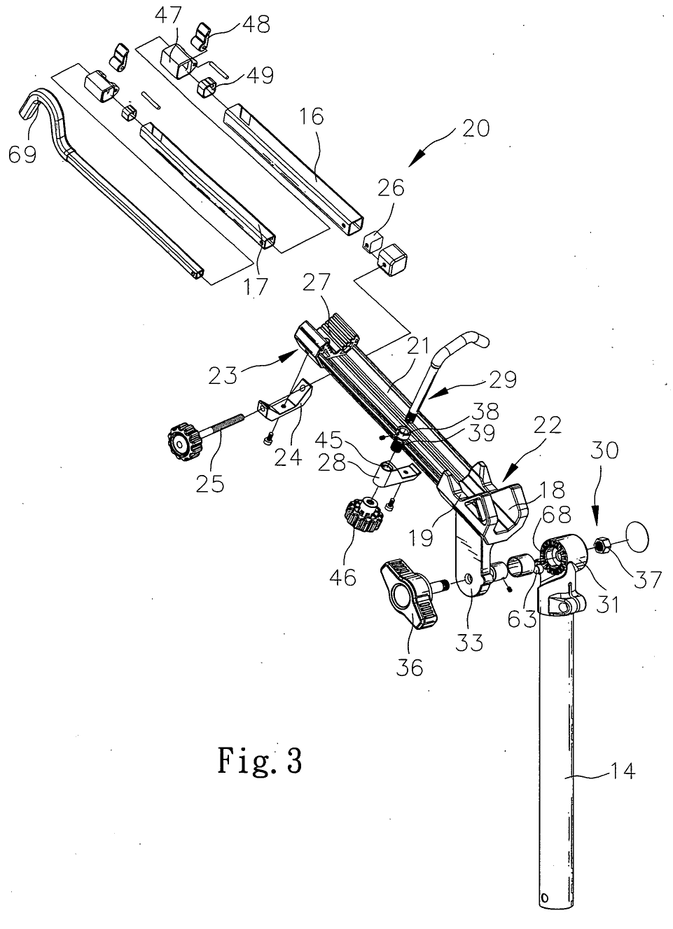

Referring to FIGS. 3 and 7, the holder 20 includes a first beam 21 for supporting the down tube 41 the bicycle 40, a second beam 16 pivotally connected with the first beam 21, a third beam 17 telescopically connected with the second beam 16 and a hook 69 telescopically connected with the third beam 17 for hooking the handlebar 44 of the bicycle 40.

The first beam 21 includes a first seat 22 at an end and a second seat 23 at an opposite end. The first seat 22 defines a longitudinal recess 18 for receiving the down tube 41 of the bicycle 40 (FIG. 7) and a transverse recess 19 for receiving the bottom bracket 42 of the bicycle 40 (FIG. 7). The second seat 23 defines a longitudinal recess 27 for receiving the down tube 41 of the bicycle 40.

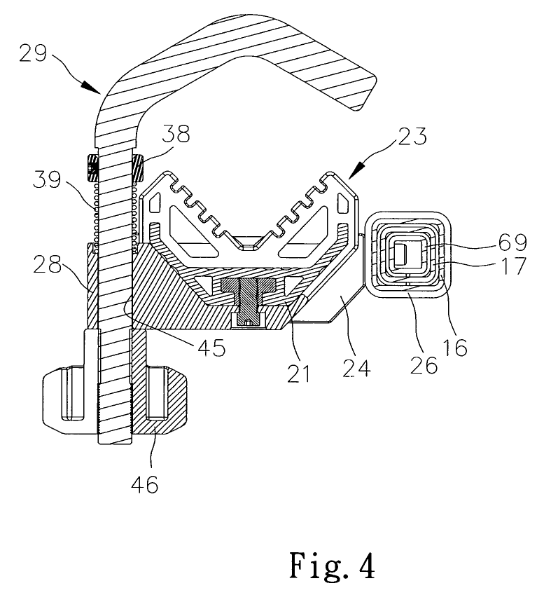

Referring to FIGS. 3 and 4, a hook 29 is movably connected with the first beam 21. The hook 29 includes an arched portion and a straight portion. The straight portion of the hook 29 is for hooking the down tube 41 of the bicycle 40. The straight portion of the hook 29 is inserted in a ring 38 secured thereto, a spring 39 and an aperture 45 defined in a connector 28 secured to the first beam 21. The straight portion of the hook 29 is formed with a thread (not numbered). A nut 46 is formed with a thread (not numbered) engaged with the thread of the straight portion of the hook 29. Thus, the spring 39 is compressed between the collar and the connector 28. The nut 46 is formed with a knob (not numbered) easily operable for rotating the nut 46. As the nut 46 is rotated in a direction, the arched portion of the hook 29 hooks the down tube 41 of the bicycle 40. As the nut 46 is rotated in an opposite direction, the arched portion of the hook 29 releases the down tube 41 of the bicycle 40.

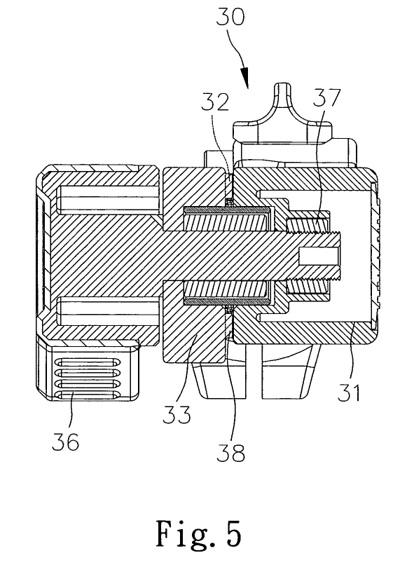

Referring to FIGS. 3 and 5, a connector 24 is secured to the first beam 21 that is a hollow element. A screw 25 is driven in a block 26 put the second beam 16 through the connector 24 and the first beam 21. Thus, the second beam 16 is pivotally connected with the first beam 21. The screw 25 is formed with a knob (not numbered) easily operable for rotating the screw 25.

A quick release is used to lock the third beam 17, which is hollow, in position on the second beam 16. The quick release includes a collar 47 connected with the second tube 15 and a cam/lever 48 connected with the collar 47 for abutment against the third beam 17. Secured to the third beam 17 is a ring 49 for contact with the cam/lever 48 in order to keep the third beam 17 in the second beam 16.

Similarly, a smaller quick release is used to keep the hook 69 in position on the third beam 17. Similarly, a smaller ring is secured to the hook 69 in order to keep the hook 69 in the third beam 17.

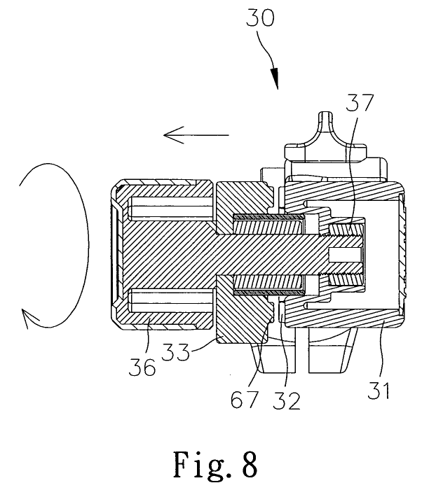

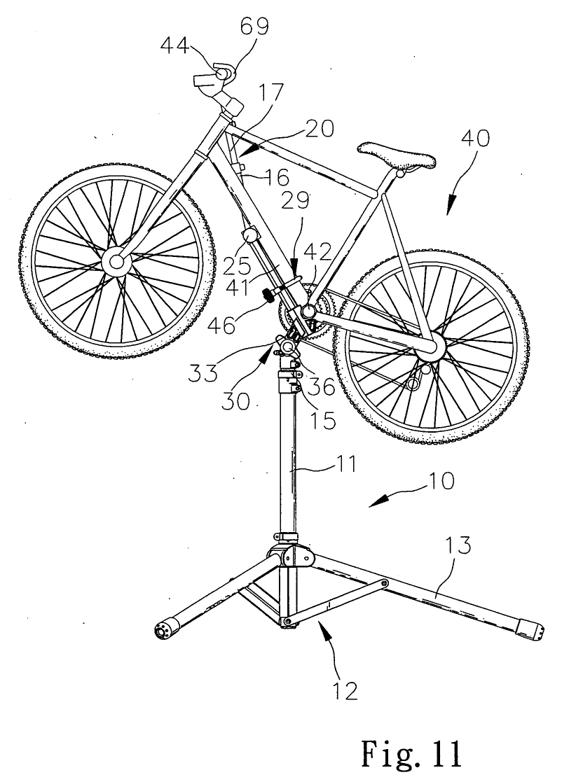

Referring to FIGS. 3, 8 and 11, the joint 30 includes an ear 33 extending from the first beam 21, an ear 31 installed on the upper tube 14, a screw 36 inserted in the ears 31 and 33 and a nut 37 engaged with the screw 36. The ear 33 includes a toothed side 67. The ear 31 includes a toothed side 32 for engagement with the toothed side 67 of the ear 33 in order to lock the holder 20 in desired angular positions on the stand 10. The screw 36 is formed with a butterfly knob easily operable for rotating the screw 36.

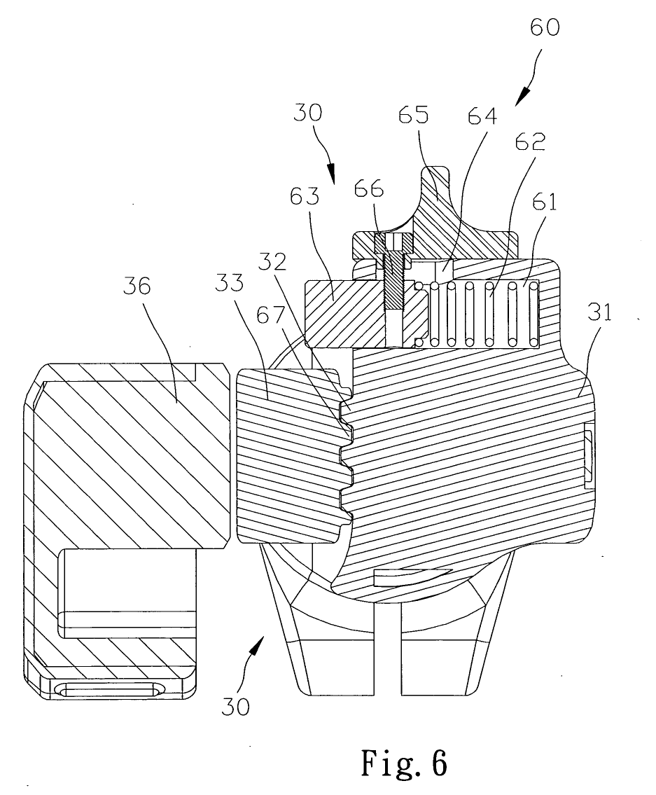

Referring to FIG. 6, the security device 60 includes a pocket 61 defined in the ear 31 or the upper tube 14, a spring put in the pocket 61, a bar 63 partially put in the pocket 61, a slot 64 communicated with the pocket 61 and a handle 65 secured to the bar 63 by means of a screw 66 inserted through the slot 64. The bar 63 is for contact with the ear 33 in order to limit the pivotal of the holder 20 on the stand 10. The handle 65 is operable for pushing the bar 63 into the pocket 61.

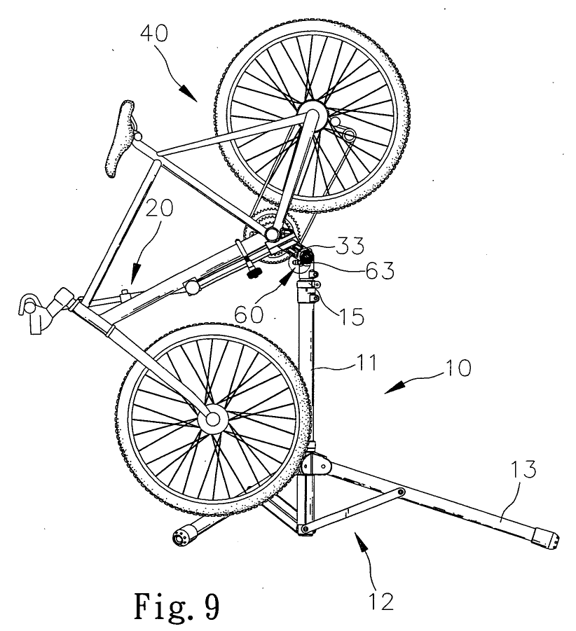

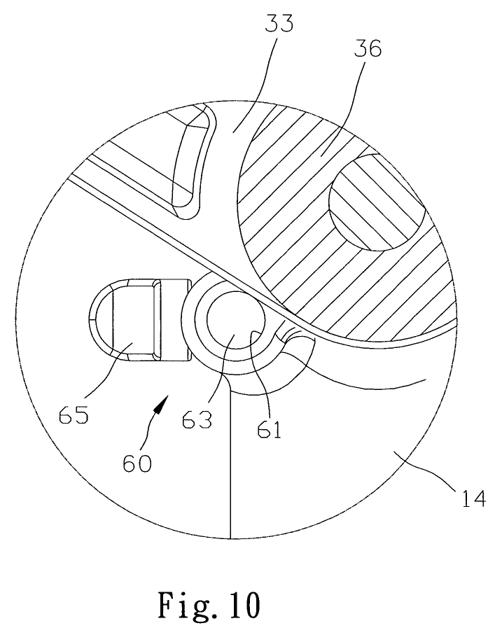

Referring to FIGS. 9 and 10, when the holder 20 is pivoted to a certain degree, the ear 33 contacts the bar 63. Thus, the pivotal of the holder 20 and the bicycle 40 on the stand 10 is limited.

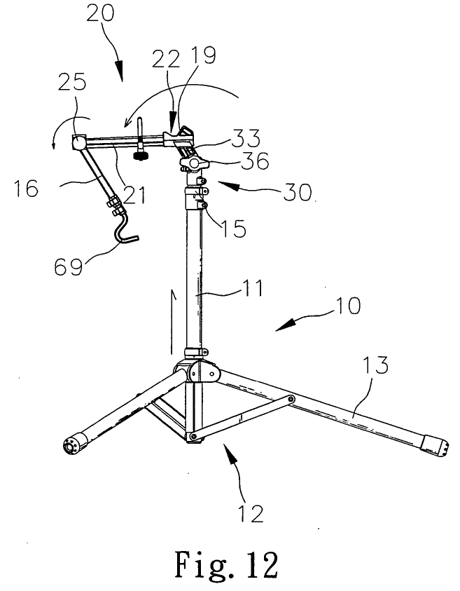

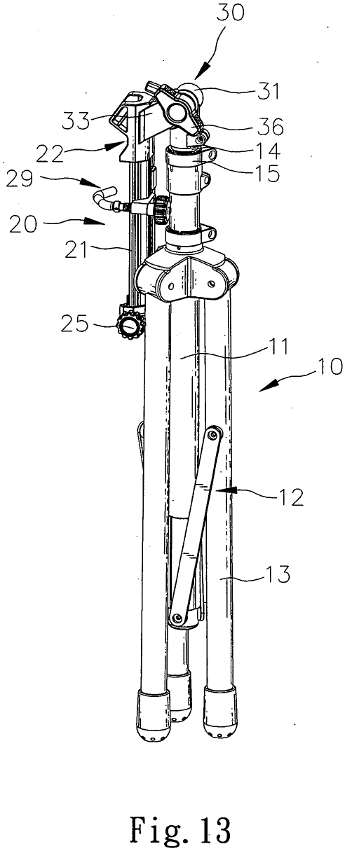

Referring to FIGS. 12 and 13, the upper tube 14 is withdrawn in the lower tube 11. The third tube 16 is withdrawn in the second tube 15. The hook 69 is withdrawn in the third tube 16. The second beam 16, the third beam 17 and the hook 69 are all pivoted to the first beam 21. The first beam 21, the second beam 16, the third beam 17 and the hook 69 are all pivoted to the lower tube 11. The legs 13 are withdrawn.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A rack for a bicycle, the rack comprising:
a collapsible stand comprising a lower tube, an upper tube telescopically connected with the lower tube and three legs pivotally connected with the lower tube; and
a holder installed on the collapsible stand in order to hold the bicycle in position.

2. The rack according to claim 1 comprising a quick release for locking the upper tube in position on the lower tube.

3. The rack according to claim 1 wherein the holder comprises a beam for supporting the down tube of the bicycle.

4. The rack according to claim 1 wherein the holder comprises a hook connected with the beam in order to hook the handlebar of the bicycle.

5. The rack according to claim 4 comprising a seat installed on the beam for supporting the bottom bracket of the bicycle.

6. The rack according to claim 5 wherein the seat defines a transverse recess for receiving the bottom bracket of the bicycle.

7. The rack according to claim 6 wherein the seat defines a longitudinal recess for receiving the down tube of the bicycle.

8. The rack according to claim 5 comprising an additional seat arranged on the beam for supporting the down tube of the bicycle.

9. The rack according to claim 8 wherein the seat defines a longitudinal recess for receiving the down tube of the bicycle.

10. The rack according to claim 4 wherein the holder comprises a telescopic device arranged between the beam and the hook.

11. The rack according to claim 10 wherein the telescopic device comprises a first tube and a second tube telescopically connected with the first tube.

12. The rack according to claim 11 wherein the telescopic device comprises a quick release for locking the second tube in position on the first tube.

13. The rack according to claim 11 wherein the first tube is connected with the beam, wherein the second tube is connected with the hook.

14. The rack according to claim 13 wherein the first tube is pivotally connected with the beam.

15. The rack according to claim 14 wherein the holder comprises a block secured to the first tube and a screw driven in the block through the beam.

16. The rack according to claim 11 wherein the second tube is telescopically connected with the hook.

17. The rack according to claim 16 wherein the holder comprises a quick release for locking the hook in position on the second tube.

18. The rack according to claim 4 wherein the holder comprises an additional hook connected with the beam for hooking the down tube of the bicycle.

19. A rack for a bicycle, the rack comprising a collapsible stand, a holder for holding the bicycle in position and a joint for connecting the holder with the collapsible stand.

20. The rack according to claim 19 wherein the joint comprises an ear extending from the holder, an ear arranged on the collapsible stand, a screw driven into the ears and a nut engaged with the screw.

21. The rack according to claim 20 wherein the ear extending from the holder comprises a toothed side, wherein the ear arranged on the collapsible stand comprises a toothed side for engagement with the toothed side of the ear extending from the holder.

22. The rack according to claim 19 wherein the collapsible stand comprises a post and at least three legs pivotally connected with the post.

23. The rack according to claim 22 wherein the post comprises a lower tube with which the legs are pivotally connected and an upper tube telescopically connected with the lower tube.

24. The rack according to claim 23 comprising a quick release for locking the upper tube in position on the lower tube.

25. The rack according to claim 19 wherein the holder comprises a beam for supporting the down tube of the bicycle and a hook for hooking the handlebar of the bicycle.

26. The rack according to claim 25 comprising a seat installed on the beam for supporting the bottom bracket of the bicycle.

27. The rack according to claim 26 wherein the seat defines a transverse recess for receiving the bottom bracket of the bicycle.

28. The rack according to claim 27 wherein the seat defines a longitudinal recess for receiving the down tube of the bicycle.

29. The rack according to claim 26 comprising an additional seat arranged on the beam for supporting the down tube of the bicycle.

30. The rack according to claim 29 wherein the seat defines a longitudinal recess for receiving the down tube of the bicycle.

31. The rack according to claim 25 wherein the holder comprises a telescopic device arranged between the beam and the hook.

32. The rack according to claim 31 wherein the telescopic device comprises a first tube and a second tube telescopically connected with the first tube.

33. The rack according to claim 32 wherein the telescopic device comprises a quick release for locking the second tube in position on the first tube.

34. The rack according to claim 32 wherein the first tube is connected with the beam, wherein the second tube is connected with the hook.

35. The rack according to claim 34 wherein the first tube is pivotally connected with the beam.

36. The rack according to claim 35 wherein the holder comprises a block secured to the first tube and a screw driven in the block through the beam.

37. The rack according to claim 32 wherein the second tube is telescopically connected with the hook.

38. The rack according to claim 37 wherein the holder comprises a quick release for locking the hook in position on the second tube.

39. The rack according to claim 25 wherein the holder comprises an additional hook connected with the beam for hooking the down tube of the bicycle.
